(19) United States
(12) Patent Application Publication
(10) Pub. No.: US 2022/0238118 A1
(43) Pub. Date: Jul. 28, 2022

(54) APPARATUS FOR PROCESSING AN AUDIO SIGNAL FOR THE GENERATION OF A MULTIMEDIA FILE WITH SPEECH TRANSCRIPTION

(71) Applicant: CEDAT 85 S.R.L., SAN VITO DEI NORMANNI (IT)

(72) Inventor: GIANFRANCO MAZZOCCOLI, SAN VITO DEI NORMANNI (IT)

(21) Appl. No.: 17/617,622

(22) PCT Filed: Jun. 14, 2019
(86) PCT No.: PCT/IB2019/054993

§ 371 Date: Dec. 9, 2021

(51) Int. Cl. G10L 17/14; G10L 17/18; G10L 25/24; G10L 21/028; G10L 17/02; G06F 3/16

(52) U.S. Cl. CPC G10L 17/14; G10L 17/18; G10L 25/24; G06F 40/143; G10L 17/02; G06F 3/165; G10L 21/028

(57) ABSTRACT

Apparatus for processing a signal to be processed, in particular an audio signal or a signal comprising an audio track, comprising a portable container which houses at least one processor; and ports for interfacing externally, suitable for connection with means for acquiring the audio signal to be processed. The apparatus includes a control module (10) for controlling the processing procedure; a module (22) for processing the input signal to be processed; a speech transcription module (40); a diarization module (30) for recognizing and tracking each change of speaker in the second sampled audio signal; a module (50) for generating a multimedia file, and diarization module (30), at least one multimedia PDF containing an audio and/or video digital file. The multimedia PDF allows synchronized playback of the digital file and/or navigation of the transcribed text.

The present invention relates to an apparatus for processing a signal and a method for the generation of at least one multimedia file with transcription of the speech contained in the processed signal.

It is well-known, in the technical field of speech transcription, that there exists the need to perform the automatic transcription, substantially in real time, of that which has been said by one or more persons speaking in a given environment.

This need arises in a variety of areas such as, for example, recording of the minutes for the meetings of boards of directors of companies or meetings of government bodies, conference events, court proceedings, but such an application may also be used to facilitate, for example, medical reporting.

It is also known that the current continuous speech recognition systems based on extensive dictionaries (with 500,000 words and more), so-called LVCSR, require substantial computing capacity, usually guaranteed by sets of servers, and are limited to the transcription of speech.

The technical problem which is posed, therefore, is that of providing an apparatus capable of effectively transcribing speech, substantially in real time, it being particularly desirable that the apparatus should be portable, capable of automatically transcribing the speech of a plurality of persons speaking in the same environment and producing a multimedia file with the audio synchronized with the transcribed text such that, if necessary, searches may be carried out in the text.

It is also required that the apparatus should preferably be able to recognize the individual speakers, identifying them in the context of the transcription and within the multimedia file.

In connection with this problem, it is also desirable that the apparatus should be able to display the transcription of the speech in real time during the conversation.

It is desirable that the apparatus should be easy and inexpensive to produce and assemble and be able to be installed easily at any user location using standard connection means and/or be able to ensure the security of transcribed material (the contents of which may be confidential), preventing unauthorized access thereto.

These results are obtained according to the present invention by an apparatus for processing a signal according.

The present invention also relates to a method for generating at least one multimedia file with transcription of the speech contained in the audio signal. With such an apparatus or method it is possible to generate a multimedia PDF which includes a video and/or audio digital file corresponding to a signal to be processed, associated with a transcription of the speech contained in the signal to be processed and with identification of a speaker who most probably generated the speech; the multimedia file also allows playback of the digital file and/or navigation of the transcribed text which are synchronized. In this way, it is possible to obtain a compact and portable apparatus which generates a single file with an innovative format and can also be used by unskilled personnel to record speech in a wide variety of situations, producing directly a single file which contains all the relevant information and which may be easily consulted.

Further details may be found in the following description of a non-limiting example of embodiment of the subject matter of the present invention provided with reference to the attached drawings, in which:

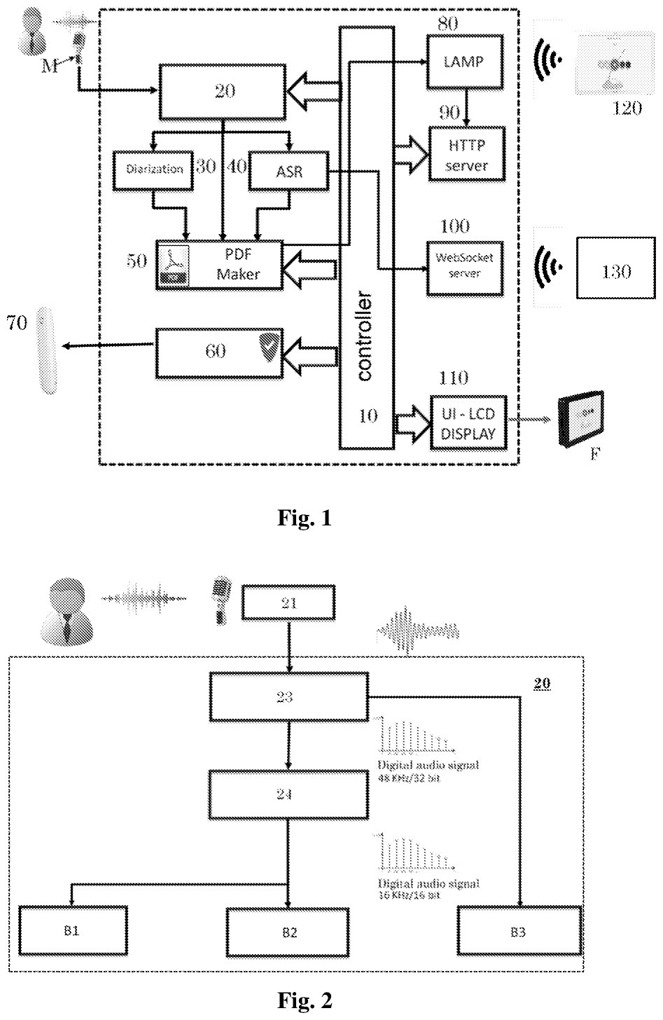

FIG. 1 shows a schematic illustration of the structure of an apparatus according to the invention cooperating with a number of peripherals devices;

FIG. 2 shows a block diagram of some functional elements of a speech acquisition module of the apparatus according to FIG. 1;

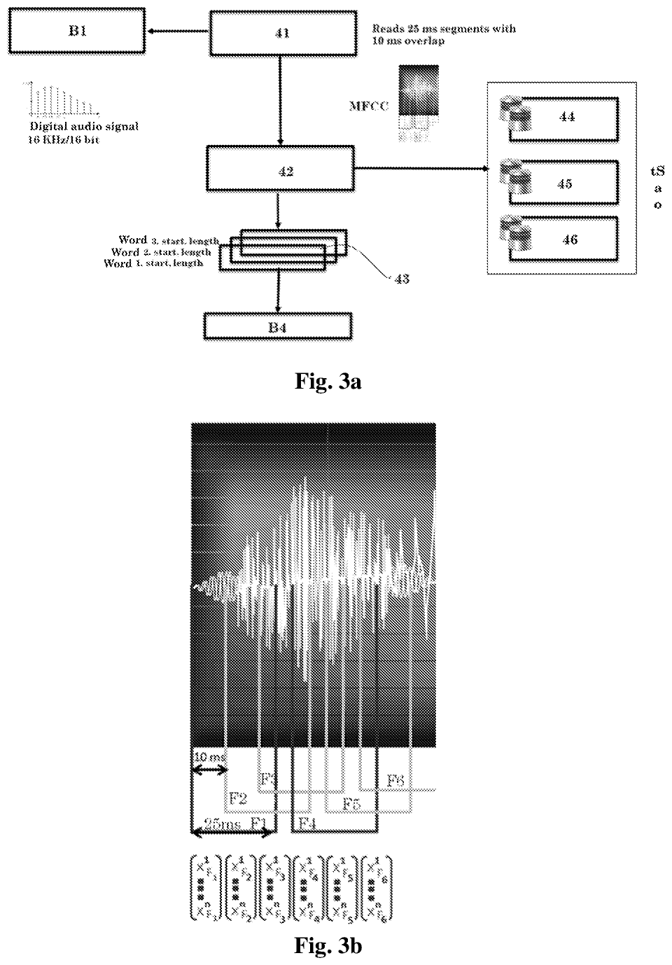

FIG. 3a shows a block diagram of some functional elements of a speech transcription module of the apparatus according to FIG. 1;

FIG. 3b shows a detailed view of a schematic example of processing for the extraction of MFCC coefficients vectors from an audio signal;

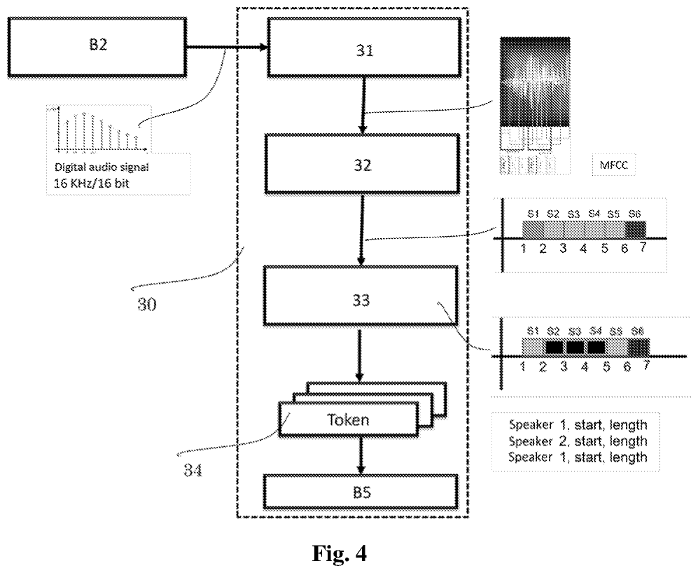

FIG. 4 shows a block diagram of some functional elements of a speech diarization module of the apparatus according to FIG. 1;

FIG. 5 shows a block diagram of some functional elements of a multimedia PDF creation module of the apparatus according to FIG. 1;

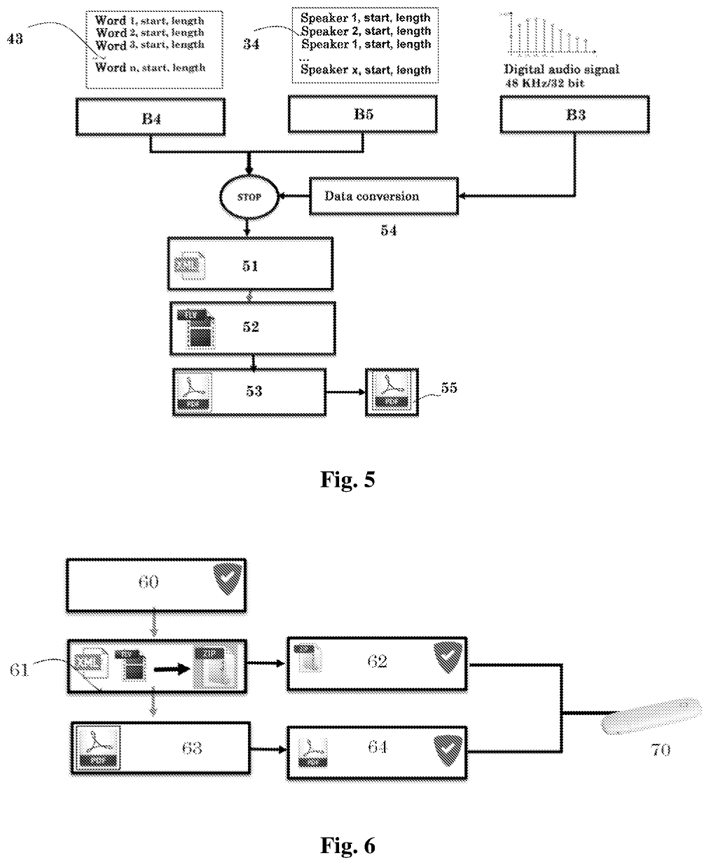

FIG. 6 shows a block diagram of some functional elements of an encryption module of the apparatus according to FIG. 1;

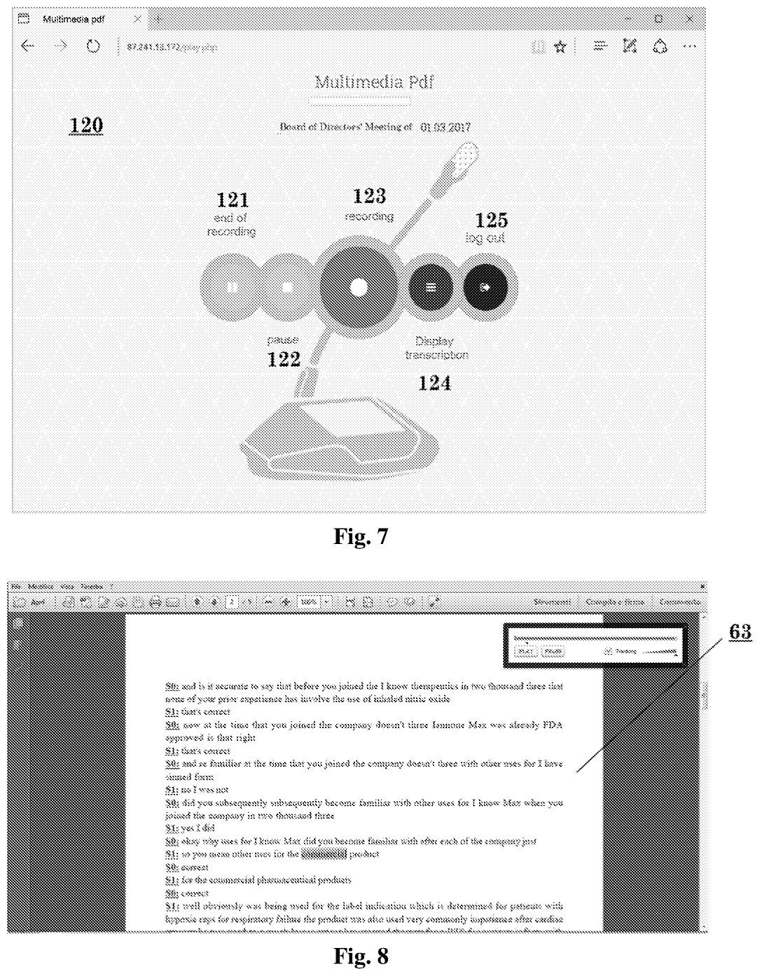

FIG. 7 shows an illustration of an example of a graphical interface of the apparatus according to the invention;

FIG. 8 shows an illustrative example of a multimedia file generated with the apparatus according to the invention; and

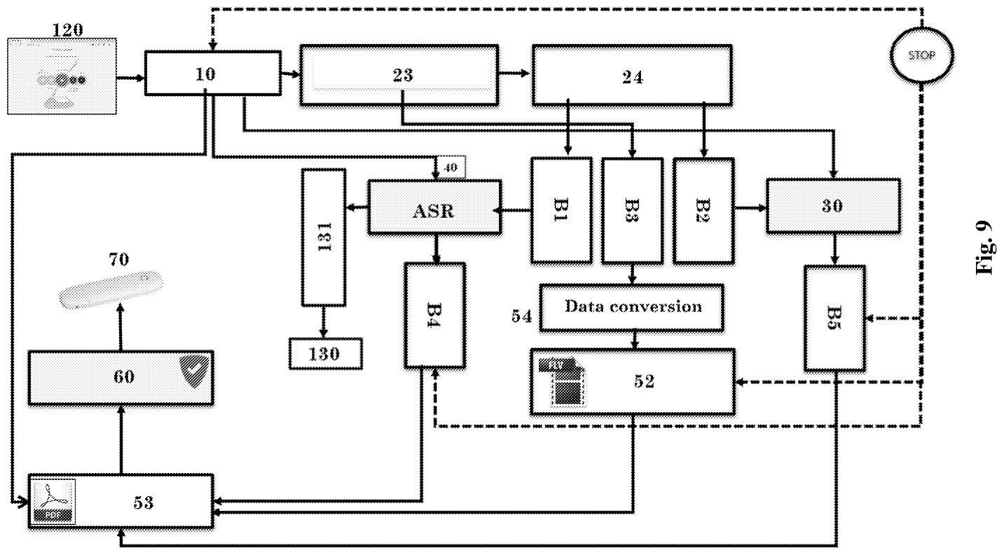

FIG. 9 shows a schematic flow diagram for execution of a method according to the invention.

To facilitate understanding of the description of the invention, the following definitions are given:

ASR (Automatic Speech Recognition): process for automatic speech recognition and text transcription.

ASV (Automatic Speaker Verification): automated process for recognition of a speaker.

Clustering: Clustering or group analysis means a multi-faceted analysis of data aimed at selecting and grouping homogeneous elements into a data set. Clustering techniques are based on measurements relating to the similarity between the elements of the set. In many processes this similarity, or dissimilarity, is conceived in terms of relative distance in a multidimensional space.

Hierarchical clustering: a clustering technique which constructs a hierarchy of partitions characterized by an increasing (or decreasing) number of groups, which can be visualized by means of a tree representation (dendrogram), in which the group formation/division stages are shown.

Phone: sound, a minimum sound unit into which a word can be broken down, regardless of the linguistic system to which the sound belongs.

Triphone=the spectrogram of a single phone varies enormously depending on the context (context refers to the phones preceding it and the phones following it). A triphone is a phone in a format designed to contain information about its context (for example, the phone Z preceded by the phone x and followed by the phone y).

Language model: is a probability distribution carried out on the word sequences of a linguistic system.

Dendrogram: a graphic tool for visualization of the similarity coefficient quantified in a “grouping” process.

In clustering techniques, the dendrogram is used to provide a graphical representation of the process for the grouping of instances (or statistical units, or records, or elements of the whole), which expresses:
along the X axis, the logical distance of the clusters according to the defined metric
along the Y axis, the hierarchical level of aggregation (positive integers)

The choice of the hierarchical level (Y axis value) defines the partition representing the grouping process.

Dictionary or Vocabulary: list of written forms of a linguistic system followed by their phonological transcription.

FST: Finite-State Transducers

HMM: Hidden Markov Model. This is an extended version of a Markov chain. The observable part is represented by a probabilistic function (discrete or continuous) relating to a state. This model is a stochastic process doubly integrated with an underlying stochastic process which is not directly observable (hidden).

The component which is hidden is the sequence of states needed to generate a given output sequence (observations).

LAMP: acronym for a type of software platform designed for the development of web applications. It takes its name from the initials of the software components which form it:
Linux—Operating System
Apache—Web Server
MySQL—database server
Perl, PHP, PYTHON programming languages

TOKEN list: this is a list or an array of objects (tokens); each token in the list is for example a vector which contains a plurality of elements.

MFCCs—(Mel-Frequency Cepstral Coefficients): these are coefficients representing characteristics of the audio signal.

Digital audio signal: a series of scalar integers called samples obtained by sampling, quantization and digital encoding of an audio signal. If the sampling rate is 16 kilohertz, there will be 16,000 samples per second.

Audio segment: portion of a digital audio signal of given length; assuming, for example, a sampling frequency of 16 khz, an audio segment of 25 ms will be composed of 400 samples.

Frame: audio segment of minimum length into which the digital audio signal to be analyzed is divided.

STT (Speech To Text): process which analyzes speech and produces an equivalent textual form.

WFST: Weighted Finite-State Transducers

With reference to FIG. 1, this shows in schematic form the architecture of an example of embodiment of a portable apparatus for processing an audio signal according to the invention.

This apparatus is particularly suitable for acquiring an analog audio signal which contains an unknown amount of speech spoken by an unknown number of speakers, and processing it to generate at least one multimedia file comprising a transcribed text of what has been said in the speech, synchronized with an audio track of the audio signal and with information about the speaker who generated said text.

A preferred embodiment of the apparatus comprises a single portable container housing the following hardware elements:
a processor, such as a 4-core CPU;
a volatile memory (RAM);
a non-volatile memory (e.g. HD, SD)
means for managing the power supply
external interface ports: comprising for example a USB port, a line-out port for an output line, a line-in input port for a signal comprising an audio track, a video output port, and an ethernet port;
preferably a touch display.

Means for acquiring an audio signal or a signal comprising an audio track, preferably comprising a microphone array M, may be connected to the line-in input port. The input signal may also be for example a video signal with an audio track.

An operating system and/or a LAMP platform and/or other functionalities described below may be installed in this architecture.

With reference to FIG. 1, the apparatus is configured in such a way that it is provided with the following components, generally realized in the form of software and algorithms programmed on the apparatus and executed by means of the processor:
a controller module 10 for supervising the processing procedure and/or for communicating with the various peripheral devices which may be connected to the apparatus;
a module 20 for processing the input audio;
an ASR module 40 for real-time transcription of speech;
a diarization module 30, configured, in particular, for recognizing and tracking a change of speaker;
a module 50 for creation of at least one multimedia file.

With reference to FIG. 2, the input audio processing module 20 is configured to receive the audio signal or signal comprising an audio track, for example an analog signal acquired via a microphone M connected to the apparatus via a line-in port 21, and to output a first digital audio signal for example at 48 KHz/16 bit.

The audio processing module 20 is also designed to sample the audio input signal at a frequency, preferably 16 KHz/16 bit PCM, suitable for processing by the transcription module 40 and diarization module 30, and to emit a corresponding sampled signal which is entered in at least one first buffer B1, and at least one second buffer B2 for respectively keeping the sampled signal available for the ASR transcription module 40 and the diarization module 30.

According to a preferred example of embodiment, the input audio processing module 20 comprises:
an acquisition manager module 23, which can cooperate with an operating system component (e.g. an ALSA driver) that allows automatic configuration of sound cards and management of multiple audio devices, for acquisition of the digital audio signal at 48 KHz/16 bit. The digital signal acquired is entered in a special buffer B3 which keeps it available for the multimedia file creation module 50.
a frequency re-sampling module 24 which is able to receive the audio signal from the acquisition manager module 23 and convert it from 48 KHz to 16 Khz (or other suitable sampling frequency) for the following ASR and diarization modules.

The re-sampled signal is entered in at least one first buffer B1 and at least one second buffer B2.

With reference to FIG. 3a, the ASR module 40 for automatic speech transcription is configured to receive at its input the audio signal made available in the first buffer B1 and output a list of words which are, a transcription of the speech contained in the input sampled audio signal, together with temporal information about the position of words transcribed in the audio signal itself.

With reference still to FIG. 3a, a preferred embodiment of the ASR transcription module 40 comprises:
a features extractor 41 configured to:
process the sampled signal present in the at least one first buffer B1 and extract voice characteristics relevant for speech recognition; and/or
output a stream of feature vectors, suitable for automatic speech recognition processing.

With reference still to FIG. 3a, according to a particularly preferred embodiment of the ASR transcription module 40:

in general, the audio signal is processed in such a way that the relevant characteristics are extracted and presented in a format that is suitable for interpretation by a speech transcription processing module.

Preferably the voice characteristics extractor is configured for the extraction of voice characteristics in the form of MFCC coefficients and the creation of one or more corresponding MFCC feature vectors. With reference to FIG. 3b, a preferred method for the extraction of features (voice characteristics) and the construction of the feature (characteristics) vector includes the following steps:
-) sampling of the digital audio signal sampled from the first Buffer B1;
-) subdivision of the digital audio signal into consecutive frames of equal duration (e.g. 25 ms) and period (e.g. 10 ms), preferably with an overlap between adjacent frames and for example using a hamming window function so that in the overlapping portion between adjacent frames the signal is attenuated.
-) DFT (Discrete Fourier Transform): The discrete Fourier transform, which transforms the interval from the time domain to the frequency domain, is calculated for each frame;
-) Filtration at Mel frequencies:

Since the human hearing system is not sensitive to phase variations, it is sufficient to consider the amplitude spectrum.

In addition, since human hearing is not able to distinguish very close frequencies, band-pass filters are applied and the energies of the frequencies contained in each band are added together. The amplitude of these bands is defined by the Mel scale.

Finally, the logarithm of these energies is calculated, since human hearing does not perceive the intensity on a linear scale.

Extraction of Mel-Frequency Cepstral Coefficients (MFCC):

Since the filters used in the preceding step are superimposed, the resultant energies are also very closely correlated. They are therefore de-correlated by applying the discrete cosine transform (DCT). The MFCCs, i.e. the coefficients resulting from the application of the DCT to each filtered DFT of each frame, are thus obtained.

At the output of the features extractor 41 there is therefore a stream of vectors F1, . . . , Fn of MFCC coefficients each comprising a suitable number, preferably between 13 and 40, of MFCC coefficients extracted from a respective frame of the digital audio signal.

The ASR module also preferably comprises an acoustic model 45, which is a classifier that associates with each frame of the audio signal one or more phones of a set of reference phones which comprises a list of phones useful for describing a certain language (the phones are independent of the language, but a subset thereof relating to the language is used). These phones may be combined to form words. For example, the word “ciao” consists of three phones “tS” “a” and “o”.

Preferably, the acoustic model is composed of a recurrent deep neural network and is configured to receive at its input the stream of vectors F1, . . . , Fn of MFCC characteristics associated with each frame and to emit a corresponding stream of triphones most probably corresponding to the sound of each frame of the audio signal.

The output of the acoustic model is the most probable triphone, i.e. the most probable phone taking into account the context.

The output of the neural network is used by a search module, together with the information contained in a dictionary and a language model, to determine the sequence of most probable words associated with a given segment of the analyzed audio signal and create a corresponding list of tokens.

The language model 44 is a probability distribution of the sequences of words. The language model is used by the search module to decide between sequences of words with similar sounds. For example, the Italian phrases “prevista la missione it 15 se andiamo” and “e vista l′ammissione quindi ci sentiamo” have a similar sound but it is much more likely that the first one will occur and therefore the language model will give it a higher score.

The dictionary 46 contains a list of written words associated with the respective phonological transcription (in the form of phones).

The search module 42 is designed to determine the word or sequence of words among those contained in the dictionary that is statistically closest to the sound of the sampled audio signal.

The search module operates by receiving at its input an output of the acoustic model and, based on the information contained in the language model and in the dictionary, outputs a list of tokens 43 each containing:
the word (WORD), with the greatest probability of having been spoken in a given segment of the audio signal;
the starting point (START), expressed in number of frames of predefined length and period (typically 10 ms) of the audio segment containing the word, and
the length (LENGTH) in number of frames of predefined length and period (typically 10 ms) of the said audio signal segment.

The list of tokens is sent to a respective buffer B4 for use by the module for creating a multimedia file (PDF).

According to an example of embodiment, the search module 42 enters the information about the language model, dictionary, phonetic context and an HMM in a finite-state transducer which realizes a static search graph.

If the apparatus is used in specific contexts (e.g. medical, political or financial contexts) and the speech contains particular words, such as product names or specific words/phrases which are rarely used in everyday language, better performance can be achieved by customizing the language model.

For example, if the apparatus is used in the medical field, some terms, such as “atrophy”, “COPD”, “CAT”, or “diuresis”, are likely to occur more frequently than in an everyday conversation. By customizing the language model, the system can learn these terms.

With reference to FIG. 4, this shows a preferred diarization module 60 able to detect one or more changes of speaker in the audio signal which contains an unknown amount of speech and also an unknown number of speakers. Preferably the diarization module 60 is also able to identify chunks of the audio signal included between two speaker changes and therefore generated by the same speaker. Preferably, the diarization module is also able to identify all the chunks spoken by the same speaker. The diarization module may also be configured to identify each different speaker detected and, if necessary, associate the speaker with identification information entered by the user.

With reference to FIG. 4, a preferred example of embodiment of the diarization module 60 is able to call up a features extractor 31 for the extraction of a respective MFCC coefficients vector from each frame of the respective audio signal present in the buffer B2.

The features extractor 31 may be similar to the extractor 41 already described and preferably in common for the ASR transcription module 40 and diarization module 30. However, generally, not all the extracted coefficients are used, and in particular the diarization module uses a smaller number of MFCC coefficients than those used by the extraction module 41 of the ASR module, and preferably a number between 11 and 15, more preferably the first 13 MFCC coefficients extracted. This number of coefficients is sufficient for the purposes of the diarization module 30 and results in a reduction of computational capacity needed.

The stream of MFCC vectors obtained is sent to a segmentation module 32 able to subdivide the MFCC vectors representing the audio signal into homogeneous audio segments of predefined duration, identify each change of speaker in said segments of predefined duration and output information on the position in the audio signal of the audio signal chunks included between adjacent speaker changes.

In greater detail, the GLR segmentation module 32 subdivides a stream of MFCC vectors representing the audio signal correspondingly into small homogeneous segments of the audio signal, of predefined duration, for example of about 2 seconds.

The GLR segmentation module 32 then calculates a relative distance (similarity) between two adjacent audio segments to determine whether the speech present in the audio signal at these segments belongs to the same speaker or to different speakers and therefore whether a speaker change point exists in the audio signal at said analysed segments.

To obtain this calculation of the relative distance and subsequent determination, the segmentation module can, for example, proceed as follows:

two adjacent audio segments I and J, from which the MFCCs (Xi and Xj) have been extracted by means of the extractor 31, are considered.

Each segment represented by the respective MFCCs is modelled (the trend of Xi and Xj approximated) with a respective Gaussian mixture Mi and Mj. Then, the segment produced by the union of the two adjacent segments I and J is modelled with a respective Gaussian mixture (Mi+j).

The ratio Mi+j/(Mi*Mj) is compared with a threshold value (empirically defined) and, on the basis of the result of this comparison, it is determined whether the two segments refer to two different speakers or not.

For this determination it is also possible to use, as an alternative or in combination, other techniques for calculation of a relative distance in a multidimensional space, such as single-link proximity, average-link proximity or complete-link proximity algorithms, or techniques for calculation of the distance between centroids.

Each pair of adjacent speaker changes detected in the audio signal therefore determines the position in the audio signal itself of a respective signal chunk pronounced a same speaker (and included between the two speaker changes).

According to the preferred embodiment shown, downstream of the segmentation module 32, there is a hierarchical agglomeration module 33, configured to determine which of the audio chunks (S1, S2) between two successive speaker changes identified by the segmentation module 32 belong to the same speaker and to emit a corresponding sequence/list of tokens, each relating to a respective one of said chunks of the audio signal and containing an identification of a speaker with the greatest probability of having spoken in the respective audio chunk comprised between two successive speaker changes, the starting point in number of frames of the audio chunk (START), and the length in number of frames of the audio chunk (LENGTH).

To perform this determination, the agglomeration module 33 may use clustering techniques in which the similarity, or dissimilarity, between two audio chunk is conceived in terms of relative distance in a multidimensional space. Preferably, the module 33 uses one or more hierarchical clustering techniques in which all chunks of the audio signal included between adjacent speaker changes, which have been identified by the segmentation module 32, are compared in pairs by means of calculation of the relative distance between the two chunks.

For this determination it is possible to use the comparison technique described in relation to the segmentation module and preferably, alternatively or in combination, also techniques for calculation of a relative distance in a multidimensional space, such as single-link proximity, average-link proximity or complete-link proximity algorithms, or techniques for calculation of the distance between centroids.

Like the segmentation module 32, for the analysis of audio signal chunks, the agglomeration module 33 can operate on the MFCC coefficients representing the said chunks.

For example, the agglomeration module 33 initially assumes that each chunk of the audio signal comprised between two speaker changes, identified by the segmentation module, is associated with a different speaker. Then, pairs of chunks initially associated with different speakers are compared with each other using one or more metrics for calculation of the relative distance to determine whether the speech present in the audio signal at these chunks belongs to the same speaker. The techniques used may be those already described previously in relation to the GLR segmentation module. The module 33 proceeds in this way for all possible pairs of audio signal chunks included between two successive speaker changes identified by the segmentation module. Where two audio chunks are identified as having been generated by the same speaker, the agglomeration module will associate these chunks with a same speaker identification.

If there is a database present in which identification information about different speakers has been entered beforehand, in some cases associated with a voice imprint of the said speakers, it is possible to associate a speaker with one of these speakers. At the end of this agglomeration procedure, if present, the diarization module emits a list of 64 tokens, each relating to a respective audio signal chunk and including an identification of the speaker (speaker 1) with the greatest probability of having spoken in the respective audio signal chunk, the starting point of the audio chunk (START) in number of frames of predefined duration, and the length (LENGTH) of the audio chunk in number of frames.

The list of tokens 24 generated is then sent to an output buffer B5 so as to make it available for the multimedia file creation module.

Multimedia File (PDF) Creation Module

During the recording step, the ASR module 40 and diarization 30 module enter the lists/sequences of tokens generated into the respective output buffers B4, B5; at the same time, the acquisition module 16 enters the data of the sampled audio signal in buffer B3.

During the multimedia, e.g. PDF, file creation step—which may be started, for example, by activating a record interrupt command 51—the controller 10 takes control of the process and calls a module 50 for generation of a multimedia file which contains the following modules:
an XML module able to produce an XML file with the transcription of the audio signal speech, obtained from the token list 43 emitted by the transcription module, associated with information about the speaker who generated each chunk of the transcribed speech, obtained from the token list 33 emitted by the diarization module 30 module and temporal information about the position and duration of the transcribed speech in the audio signal.

The XML module is in particular configured to read the data from the buffer B4, buffer B5 and optionally from a Data Base containing speaker identification information, entered beforehand via a web interface (present in the LAMP module 80), and produce an XML file with the transcription of the speech, obtained from the token list 43 emitted by the transcription module, associated and synchronized with information about the respective individual speakers, obtained from the token list 33 emitted by the diarization module 30.
a data conversion module 54, designed to convert the sampled audio signal (or other signal containing said audio, such as a video) produced by the acquisition module and present in buffer B3, into an audio and/or video file with a digital format suitable for use in a multimedia PDF, preferably in FLV, MP3 or MP4 format, for example with audio stream encoding parameters: MP3/44100/64 kbps;
a module 53 for generation of a multimedia PDF which is preferably adapted to receive at its input the encoded file and the XML file and to produce a multimedia PDF 55.

According to a preferred embodiment, in addition to the text of the transcribed speech, the PDF file also includes a flash technology multimedia player (such as an SWF Player) able to play back the encoded audio/video file and a JavaScript code (JSCRIPT) able to control the playback of the audio/video file and navigation of the text, in particular so as to allow playback of the file and/or navigation of the text which are synchronized with each other.

The generation module 53 may be for example a Windows client application, for manual generation of the multimedia PDF, or a JAVA application for automatic generation of the multimedia PDF.

According to a preferred example of embodiment, the generation of the multimedia PDF may be performed by means of the following steps:
the generation module 53 extracts from the XML file the sequence of words of the transcribed text with the corresponding start and duration time references;
the generation module 53 extracts from the XML file an identification of a speaker with the greatest probability of having spoken in a respective audio chunk of the transcribed speech between two successive speaker changes, with the start and duration time references of each chunk;
the text of the transcribed speech spoken in the time interval corresponding to each chunk is associated with the respective speaker;
optionally, an index of speakers is prepared, if necessary associating with each speaker identification information present in the database (if present);
the generator module creates a temporary PDF, preferably setting the page format and margins of the PDF;
the JSCRIPT code is entered in the temporary PDF file, said code performing the following functions when the PDF is opened and/or whenever a cursor is positioned on a word of the text or activates the multimedia player (SWF player):
   start/recall of the multimedia file playback by means of the multimedia player at a selected word of the file text;
   highlighting of the word in the file text (transcribed speech) with a temporal position corresponding to the moment of the media file being played back.
The generator module creates a first page of the PDF containing the multimedia player and preferably the corresponding configuration parameters of the player and, optionally, inserts for example a logo and/or a link to the multimedia player;
the generator module 53 generates, on the basis of the XML file, the pages containing the text of the transcribed speech extracted from the XML file, each word having associated with it a JSCRIPT code which contains the absolute time reference of the word and allows the media player start/recall function to be executed;
optionally, bookmarks may be inserted so as to allow positioning on a selected speaker;
the temporary PDF is closed.
The generator module opens a new PDF file and copies the temporary PDF into the new PDF file;
optionally, a footer is inserted in the new file for each page;
the multimedia file is inserted in the new PDF file;
an index XML file is created, said file containing the individual words with the respective temporal reference;
the generated index is inserted in the new PDF file;
the multimedia PDF thus obtained is saved and closed.

The generator module may be configured to receive at its input, in addition to the XML file and the multimedia file, also a template file containing information useful for generating the multimedia PDF, such as said logo, logo position, links, bookmarks, etc.

The invention is not limited to the creation of a PDF file as described above, since the person skilled in the art may configure the generator module 50 to create a similar or equivalent multimedia file which is differently encoded based on the output of the transcription, diarization and acquisition modules.

According to a preferred embodiment (FIG. 6), the apparatus also comprises an encryption module.

Once the desired multimedia files have been generated, the controller 10 calls up the encryption module 60 which takes the FLV audio file and the XML file, encrypts them 61, generates a compressed file 62 and writes the file to a dongle 70 connected to a USB port on the apparatus.

Then the encryption module 60 encrypts the multimedia PDF file 63 and saves it also on the dongle 70.

The apparatus also has preferably installed a WebSocket server, i.e. a web technology which provides full-duplex communication channels via a single TCP connection.

For example, the WebSocket protocol used complies with the RFC 6455 standard and is a service managed by the operating system.

Its function is to display in real time, on the operator's browser, the transcription 130 of speech, when the operator activates a “transcription display” mode by means of a command.

The apparatus may also include a video interface and/or a display. The video interface may be designed to manage a touch display mounted on the apparatus.

The display and the video interface can be configured to allow control of the various functions of the apparatus and its configuration.

According to an example of the use of the apparatus, for example for the automatic transcription of meetings held by (for example municipal, provincial and regional) boards and commissions, at the beginning of a session an operator establishes a connection via a network and by means of the HTTP module with the graphic interface of the apparatus, an example of which is shown in FIG. 7.

Via the interface it is possible, for example, to enter access credentials, a name for the recording, fill in the agenda, compile a list of speakers and/or perform searches within the multimedia PDF.

By activating a Record command 123, the controller starts acquisition of the audio signal and transcription of the speech.

If the View Transcription button 124 is operated, the apparatus displays the transcription in real time on the graphic interface 130 using the full-duplex communication channel offered by the web-socket protocol 131.

If during a contribution by a participant the Speaker Name button is pressed, the references of the participant on the list (previously entered in the database) may be entered and the device will mark and keep track of all the contributions of the participant in the discussion; the operation can be carried out at any time.

If the conversation is interrupted, the operator can press the Pause button 122 in order to temporarily stop the recording and transcription.

When the conversation resumes, the operator presses the Record button 123 again and the recording and transcription are resumed.

At the end of the conversation, the operator presses the End of Recording button 121, the controller, after receiving the command: generates the XML file containing the transcription and closes the FLV file containing the audio in MP3 format; completes and closes the multimedia PDF file; encrypts and saves the files on the dongle.

The operator at the end of saving the files, which takes a few seconds, can press the Log Out button 125 on the console and disconnect the dongle.

Via the graphical interface it is also possible to carry out text searches on multimedia PDFs saved on the dongle and view the results of the multimedia PDF text search synchronized with speech.

The present invention also relates to a method for processing an audio signal by means of an apparatus according to the invention, a non-limiting example of which comprises the following sequence of operational steps (FIG. 9):
an operator establishes a connection with the control interface 120 (FIG. 7), if necessary entering access credentials and setting the name of the recording. The operator can start the audio recording by pressing a record button 123;
The controller 10 receives the recording start signal from the HTTP Server module 90 and activates in sequence the following modules: data conversion module 54, diarization module 30, transcription module 40 and audio acquisition module 20;
the acquisition module 23 starts the acquisition of the digital audio signal 32 bit/48 KHz by entering the data in the buffer B3 and sending it to the sampling module 24;
the sampling module 24 receives the digital audio signal from the acquisition module 23, converts it into 16 bit/16 KHz and enters it in the buffer B1 and buffer B2;
the ASR transcription module 40 retrieves the sampled digital audio signal from the buffer B1, processes it producing the token list 43 which is sent to the buffer B4 and, if necessary, to the WebSocket server 131 for real-time display;
the diarization module 30 retrieves the digital audio signal from the respective buffer B2, processes it by detecting one or more speaker changes and generating the respective list 64 of voice chunks included between adjacent speaker changes, which is entered in the output buffer B5;
when the apparatus receives an interrupt command (e.g. sent by pressing the Stop button 51 on the display), the controller 10 sends the acquisition interrupt command to the acquisition module 23 and checks for correct completion of the audio acquisition, transcription, diarization and data conversion processes;
the acquisition module 23 interrupts the audio acquisition and stops sending of the audio signal to the sampling module 24 and the buffers B1, B2 and B3;
the multimedia file generator 50 reads the data from the buffers B4 and B5, and if necessary from the database, and processes it producing the XML file containing the transcription of the speech associated with the individual speakers of each chunk;
the multimedia file generator 50 reads the data from the buffer B3 and generates the converted audio file;
the multimedia file generator 50 processes the XML file and the converted audio file and produces the multimedia PDF containing the synchronized text and digital audio (FIG. 8);
The controller 10 checks for conclusion of the activities by the multimedia file generator 50 and, if necessary, calls up the encryption module 60 which retrieves the FLV audio file and the XML file, encrypts them 61, generates a compressed file 62 and writes the files onto the dongle 70 connected to a USB port of the apparatus.

Then the encryption module 60 encrypts the multimedia PDF file 63 and saves it on the dongle 70 as well.
The controller 10 waits to receive a new command from the console 120.

It is therefore clear how the apparatus according to the invention is compact and transportable, easy to connect, for example, to a company network and able, automatically, to record a conversation, transcribe it, distinguish between speakers, and generate a multimedia PDF, allowing a user without specific knowledge to obtain, at the end of the conversation, the transcription of the conversation which is associated with a speaker who generated it and can be navigated synchronized with an audio or video file of the event which generated the speech.

Optionally, the apparatus according to the invention is able to encrypt the data collected and save it on an external device, thus guaranteeing the confidentiality of the information contained therein.

The apparatus is easy to use even by unskilled users, and owing to the simplicity of the method according to the invention, operations involving acquisition, transcription, identification of change of speaker and creation of multimedia files may be carried out using a compact device integrated in an easily transportable housing.

The apparatus allows the dictionary to be customized for the specific field of application, resulting in a more accurate transcription of speech even in specialized areas.

Although described in connection with of a number of embodiments and a number of preferred examples of implementation of the invention, it is understood that the scope of protection of the present patent is defined solely by the claims below.

1. An apparatus for processing a signal to be processed, in particular an audio signal or a signal comprising an audio track, comprising a portable container which houses:
at least one processor; and
ports for interfacing externally, comprising at least one input port for receiving the signal to be processed, suitable for connection with means for acquiring an audio signal to be processed; the apparatus further comprising:
a control module (10) for controlling the processing procedure;
a module (22) for processing the input signal to be processed, able to produce at least one first and second sampled audio signal from said signal to be processed;
a speech transcription module (40), able to receive at its input the first sampled audio signal and to output a list of words, that are a transcription of the speech contained in the sampled audio input signal received at the input, together with temporal information relating to the position and duration of the transcribed words in the said signal to be processed;
a diarization module (30) for recognizing and tracking each change of speaker in the second sampled audio signal, able to receive at its input said second sampled audio signal and output a sequence of objects (tokens), each relating to a respective audio signal chunk comprised between two successive changes of speaker and containing an identification of a speaker (speaker 1) with the greatest probability of having spoken in the audio signal chunk, and temporal information relating to the position and duration of the respective chunk in the signal to be processed;
a module (50) for generating a multimedia file, configured to generate, based on the acquired signal to be processed and the output of said transcription module (40) and diarization module (30), at least one multimedia file containing an audio and/or video digital file corresponding to said signal to be processed, associated with a transcription of the speech contained in the signal to be processed and an identification of a speaker who most probably generated the speech transcribed;
wherein the module for generating a multimedia file is configured to generate a multimedia PDF which includes said digital file and said transcribed text and allows playback of the digital file and/or navigation of the transcribed text synchronized with each other.

2. The apparatus according to claim 1, wherein the transcription module comprises a features extractor (41) configured to process the sampled signal present in the at least one first buffer (B1) and extract voice features relevant for speech recognition, preferably in the form of a stream of MFCC coefficient vectors (F1, . . . , Fn), each comprising a predefined number of MFCC coefficients extracted from a respective frame of predefined duration of the audio signal.

3. The apparatus according to claim 1, wherein the transcription module comprises an acoustic model (45) able to associate with each frame of the audio signal one or more phones from a set of reference phones.

4. The apparatus according to claim 3, wherein said acoustic model is configured to receive at its input a stream of MFCC coefficient vectors (F1, . . . , Fn), each vector being associated with a respective frame of predefined duration of the audio signal, and to emit a corresponding stream of phonemes most probably corresponding to the sound of each frame of the audio signal.

5. The apparatus according to claim 2, wherein said acoustic model is in the form of a recurrent deep neural network.

6. The apparatus according to claim 1, wherein a language model having a probability distribution of the sequences of words in a reference language.

7. The apparatus according to claim 1, having a dictionary (46) which contains a list of words written in a reference language, each associated with a respective phonological transcription in the form of phones.

8. The apparatus according to the claim 1, wherein the transcription module comprises a search module (42) able to determine the word or sequence of words, from among those contained in the dictionary, which is statistically closest to the sound/sequence of sounds of the sampled audio signal.

9. The apparatus according to claim 1, wherein the transcription module is configured to output a list/sequence of tokens (43) each containing:
the word (WORD), which most probably was spoken in a given segment of the audio signal;
the starting point (START), expressed in number of frames of predefined duration and period, of the audio signal segment, containing the word, and
the length (LENGTH), in number of frames of predefined duration and period, of the said audio signal segment.

10. The apparatus according to claim 9, wherein the transcription module is configured to produce said list of tokens depending on the output of an acoustic model and/or the contents of a dictionary and/or a language model.

11. The apparatus according to claim 9, comprising at least one respective fourth buffer (B4) able to store the list/sequence of tokens produced by the transcription module and keep it available for the multimedia file creation module.

12. The apparatus according to any claim 1, wherein the diarization module (30) is configured to identify chunks of the audio signal comprised between two successive changes of speaker and therefore spoken by a same speaker.

13. The apparatus according to claim 12, wherein the diarization module (30) is configured to identify in the audio signal all the chunks of the signal to be processed spoken by a same speaker.

14. The apparatus according to claim 1, wherein the diarization module is configured to emit a list/sequence of tokens, each containing an identification of a speaker with the greatest probability of having spoken in a respective audio chunk comprised between two successive changes of speaker, the starting point of the chunk (START) expressed in number of frames of predefined duration of the audio signal, and the length of the chunks (LENGTH) in number of frames of predefined duration.

15. The apparatus according to claim 1, wherein the diarization module (20) is able to recall a features extractor (31) for extraction of a respective MFCC coefficient vector from each frame of the respective audio signal.

16. The apparatus according to claim 1, wherein the features extractor (31) is common to the transcription module and the diarization module.

17. The apparatus according to claim 1, wherein the diarization module comprises a segmentation module (32) able to divide up the MFCC vectors representing the audio signal into homogeneous audio segments of predefined duration and to identify each change of speaker in said segments of predefined duration.

18. The apparatus according to claim 1, wherein the segmentation module (32) is configured to calculate a similarity or relative distance between two adjacent segments in order to determine whether the speech present in the audio signal within these segments belongs to the same speaker; wherein techniques for calculating a relative distance in a multidimensional space are preferably used for said determination.

19. The apparatus according to claim 1, wherein the diarization module (30) comprises a hierarchical agglomeration module (33) configured to identify chunks of the audio signal, each comprised between two adjacent changes of speaker, which belong to a same speaker, and to emit a respective list/sequence of tokens, each containing an identification of a speaker with the greatest probability of having spoken in the audio signal chunk, the starting point in number of frames of the audio signal chunk (START), and the length in number of frames of the chunk (LENGTH).

20. The apparatus according to claim 1, wherein the module for generation of a multimedia file is configured to create a multimedia PDF which includes a flash technology multimedia player able to play back the encoded audio/video file and a JavaScript code able to control the playback of the audio/video file and the navigation of the text, in particular to allow the playback of the digital file synchronized with a navigation of the transcribed text and/or the navigation of transcribed text synchronized with the playback of the digital file.

21. The apparatus according to claim 20, wherein the module for generation of a multimedia file is configured to insert into the multimedia PDF at least one JavaScript code which performs one or more of the following functions upon opening of the PDF and/or whenever a cursor is positioned on a word of the transcribed text or activates the multimedia player:
a function for starting/recalling the playback of the multimedia file by the multimedia player in correspondence of a selected word in the file text;
a function for highlighting the word of the transcribed text with a temporal position corresponding to the moment of the multimedia file being played back.

22. The apparatus according to claim 1, wherein the module for generation of a multimedia file comprises:
an XML module able to read the data emitted by the transcription module and the diarization module and produce an XML file containing the transcription of the speech associated with information about the respective speakers who generated the speech;
a data conversion module (54) able to convert a sampled signal corresponding to the signal to be processed into an audio and/or video digital file suitable for use in a multimedia PDF;
a module (53) for generating a multimedia PDF which is configured to receive at its input the converted file and the XML file and produce the multimedia PDF.

23. A method for producing at least one multimedia file in which a signal to be processed, in particular an audio signal or signal comprising an audio track, is associated with a transcription of the speech contained in the audio signal and an identification of one or more speakers who generated the speech, comprising the steps of:
acquiring a signal to be processed, by means of acquisition means connected to an input port of a portable processing device according to claim 1;
sending the acquired signal to be processed to the module (22) for processing of the audio input signal, with production of at least one first and second sampled audio signal from the said signal to be processed;
reception of the first sampled audio signal by a speech transcription module (40), which outputs a list/sequence of words which are a transcription of the speech contained in the sampled audio input signal, together with temporal information relating to the position of the transcribed words in the signal to be processed;
reception of the second sampled audio signal by the diarization module (30) for recognizing and tracking each change of speaker, which outputs data comprising a list/sequence of speakers with the greatest probability of having spoken in a respective audio signal chunk comprised between two successive changes of speaker, together with temporal information relating to the position and duration of each chunk in the signal to be processed;
sending of the lists/sequences output by the transcription and diarization modules to the module (50) for generating a multimedia file which, based on the acquired signal to be processed and the output of said transcription and diarization modules, generates at least one multimedia file containing an audio and/or video digital file corresponding to said signal to be processed associated with a transcription of the speech contained in the signal to be processed and an identification of a speaker who most probably generated the speech;
wherein said multimedia file is a multimedia PDF which includes said digital file and said transcribed text and allows playback of the digital file and/or navigation of the transcribed text synchronized with each other.
